(19) United States
(12) Patent Application Publication
(10) Pub. No.: US 2014/0377417 A1
(43) Pub. Date: Dec. 25, 2014

(54) Automated Cooking System And Method

(71) Applicant: Yoel MARTINEZ, Hialeah, FL (US)

(72) Inventor: Yoel MARTINEZ, Hialeah, FL (US)

(21) Appl. No.: 13/921,320

(22) Filed: Jun. 19, 2013

(51) Int. Cl. A47J 27/08

(52) U.S. Cl. CPC A47J 27/0802
USPC 426/231; 99/334

(57) ABSTRACT

An automated cooking system and method that provides an efficient process for automatically dispensing at least one ingredient, agitating the at least one ingredient, and cooking the at least one ingredient to form a predetermined meal. Each ingredient rests in an interchangeable container, indicia on each container identifies the ingredient, and an indicia sensor detects the desired ingredient for dispensing. Upon command from a processor, a plurality of blades cut the film protecting the ingredients to dispense the ingredients through separate funnels into a pressure cooker and a sauce cooker. A processor regulates cooking parameters, such as duration, temperature, and order of ingredients. The sauce cooker dispenses the sauce into the pressure cooker with a tilting mechanism. A handle facilitates transport of the cooking system. A Wi-Fi reception and a USB port allow the system to receive new recipes, and other cooking related commands.

### BACKGROUND

The present invention is related to an automated cooking system and method that receives prefilled containers of ingredients into a pressure cooker and a sauce cooker at predetermined cooking parameters for automatically cooking meals.

It is well known that cooking is the art or practice of preparing food with the use of heat or cold for consumption. Cooking techniques and ingredients vary widely across the world, reflecting unique environmental, economic, and cultural traditions. Cooking involves numerous steps, such as prepping the ingredients, spicing the ingredients, and dispensing the ingredients into a cooking apparatus in a specific order.

There are very many methods of cooking, most of which have been known since antiquity. These include baking, roasting, frying, grilling, barbecuing, smoking, boiling, steaming and braising. A more recent innovation is microwaving. These various methods of cooking use differing levels of heat and moisture and vary in cooking time. The method chosen greatly affects the end result because some foods are more appropriate to some methods than others. Regulating these cooking parameters may be time consuming. Errors committed while cooking may often spoil the meal.

A barcode is an optical machine-readable representation of data relating to the object to which it is attached. Originally barcodes systematically represented data by varying the widths and spacing of parallel lines, and may be referred to as linear or one-dimensional. Indicia, such as a bar code, are useful for identifying a container. If the container includes a specific ingredient, a rotary apparatus may be operable to position the container in a desired position.

Often, a pressure cooker cooks food through a pressure cooking process. This pressure cooking process includes cooking food, using water or other cooking liquid, in a sealed vessel—known as a pressure cooker, which does not permit air or liquids to escape below a pre-set pressure. Pressure cookers are used for cooking food quicker than conventional cooking methods, which also saves energy.

In many instances, gravy is a sauce, made often from the juices that run naturally from meat or vegetables during cooking. The gravy may be further colored and flavored with gravy salt (a simple mix of salt and caramel food coloring) or gravy browning (gravy salt dissolved in water) or ready-made cubes and powders can be used as a substitute for natural meat or vegetable extracts. The gravy could be dispensed into a pressure cooker for enhancing the flavor of food.

A central processing unit is the hardware within a computer that carries out the instructions of a computer program by performing the basic arithmetical, logical, and input/output operations of the system. In some instances, the operations may include commands for regulating cooking devices, including cooking duration, temperature, and bar code identification.

Automated cooking systems have been used in the cooking industry in the past, yet none with the present characteristics of the present invention. See U.S. Pat. Nos. 7,485,830; 6,112,645; and 4,986,174.

For the foregoing reasons, there is a need for an automated cooking system and method that identifies, receives, agitates, and cooks ingredients to form a predetermined meal.

### SUMMARY

The present invention is directed to an automated cooking system that receives prefilled containers of ingredients into a pressure cooker and a sauce cooker at predetermined cooking parameters for automatically cooking meals. In some embodiments, the automated cooking system includes a housing configured to contain, cook, and protect interior components and at least one ingredient. A housing lid regulates access to the interior of the automated cooking system, and includes a vent for helping to regulate the cooking parameters and at least partially releasing vapors from the automated cooking system. Within the automated cooking system, a plurality of containers holds at least one ingredient used for cooking a predetermined meal. Those skilled in the art will recognize that the ingredients may include an eclectic variety of interchangeable ingredients. The at least one ingredient is identified and selected to prepare a meal. The selection of each ingredient is coordinated with cooking parameters, which are controlled by a processor and other data storage devices. Each container includes an indicia, such as a bar code, to indicate the type of the at least one ingredient. An indicia sensor, such as a bar scanner, detects the desired container of the at least one ingredient, and positions the container for dispensing the at least one ingredient. In this manner, myriad combinations of the at least one ingredient may be dispensed to create different meals. In some embodiments, a software program and processor regulate the dispersion of the at least one ingredient. Each container includes a sidewall and a transparent film that forms a protective cover for the top and bottom of the container to help keep the at least one ingredient fresh until dispersion. A plurality of blades position adjacent to the film, and serve to cut the film. The plurality of blades may rotatably pass in proximity to the film, and cut the film covering a predetermined container based on commands from the processor. In this manner, the at least one ingredient may dispense from the plurality of containers into a first funnel or a second funnel through a gravitational force. In some embodiments, the plurality of containers rest within a rotary apparatus. The rotary apparatus is operable to rotatably position each container for dispensing the at least one ingredient in a predetermined synchronization. In some embodiments, the rotary apparatus includes a cold portion for containing cold ingredients, and a hot portion for containing hot ingredients.

In one embodiment of the present invention, a cooker receives the at least one ingredient from the first funnel. The cooker may include, without limitation, a pressure cooker, a crock pot, an oven, and a kettle. Those skilled in the art, in light of the present teachings, will recognize that a pressure cooker is operable to cook a wide variety of meals with minimal intervention from a user. The pressure cooker performs the process of cooking food, using water or other cooking liquid, in a sealed vessel, which does not permit air or liquids to escape below a pre-set pressure. Further, pressure cookers may be utilized used for cooking food quicker than conventional cooking methods, thereby conserving energy. In one embodiment, the cooker includes a cooker lid that secures on an open end of the cooker to form a tight, high pressure seal inside the cooker. The cooker lid includes an ingredient port for receiving the at least one ingredient. The cooker lid further includes a sauce port for receiving a sauce, such as gravy. In some embodiments, a liquid container positions in proximity to the cooker to provide a liquid, including, without limitation, water to the cooker. The water may form a vapor inside the cooker for heating the at least one ingredient inside the cooker. In some embodiments, a mixing mechanism may extend into the cooker through the ingredient port for mixing the at least one ingredient in the cooker. A mixing motor may power the mixing mechanism.

In one embodiment of the present invention, a sauce cooker receives the at least one ingredient from the second funnel. The sauce cooker includes a sauce lid for preventing spillage of the sauce. A sauce lid reception port provides an aperture for the at least one ingredient to enter into the sauce cooker from the plurality of containers; whereby gravity may force the at least one ingredient into the sauce pan to form the desired sauce. In some embodiments, the sauce cooker may include a tilting mechanism that is operable to pivot the sauce cooker. In this manner, the sauce cooker may dispense the sauce through a sauce lid dispenser port, located on the sauce lid, through the sauce port on the cooker lid. The processor regulates when the sauce is sufficiently heated and mixed before actuating the tilting mechanism. The sauce cooker engages a heating device for heating the sauce. The heating device may also be operable to vibrate and tilt for mixing the sauce in the sauce cooker. In some embodiments, the heating device may include, without limitation, an electromechanical plate.

In one embodiment of the present invention, the automated cooking system includes a Wi-Fi reception portion for receiving commands pertinent to meal selection, starting times for cooking, and various cooking parameters. A USB port is configured to receive programs and commands from a data storage device for updating recipes and cooking start times.

One novel automated cooking system feature is the interchangeability of the plurality of containers holding the at least one ingredient, whereby the meals may be changed through the utilization of different ingredients.

Additional novelty is provided in that the processor works in conjunction with the WI-Fi reception portion and the USB port to change recipes and cooking parameters for enhanced regulation of the cooking process.

An objective of the present invention is to automate the dispersion, mixing, and cooking of meals by utilizing at least one ingredient in myriad possible combinations. The combination of ingredients is determined by the processor, the USB port, and the Wi-Fi reception portion, which regulate the dispensing of each ingredient in a synchronized manner to form a predetermined meal.

In yet another objective, the digital display includes timers, temperature gages, and power switches that are controlled remotely through a Wi-Fi reception portion for remotely cooking food.

In yet another objective, the time and labor required to cook is reduced since the automated cooking system dispenses, measures, agitates, and cooks the at least one ingredient with minimal outside intervention.

### DRAWINGS

These and other features, aspects, and advantages of the present invention will become better understood with regard to the following description, appended claims, and drawings where:

FIG. 1 is a detailed perspective view of the present invention showing an exemplary automated cooking system with an exemplary housing lid in a closed position;

FIGS. 2A, 2B, and 2C are detailed perspective views of the present invention showing an exemplary automated cooking system from a side view and a top view;

FIGS. 3A and 3B are front views of an exemplary automated cooking system with a housing lid in an open position;

FIGS. 4A and 4B are detailed perspective views of an exemplary rotary apparatus separated into a cold portion and a hot portion, and positioned over an exemplary plurality of blades;

FIG. 5 is a detailed perspective view of the present invention showing an exemplary automated cooking system containing an exemplary cooker, sauce cooker, and liquid container;

FIG. 6 is a sectioned view of the present invention showing an exemplary automated cooking system containing an exemplary cooker, sauce cooker, and liquid container; and

FIG. 7 is a sectioned view of the present invention showing an exemplary automated cooking system containing an exemplary cooker, sauce cooker, liquid container, rotary apparatus, plurality of blades, first funnel, and second funnel;

FIG. 8 is a flowchart diagram of the present invention showing an exemplary automated cooking method; and

FIG. 9 is a block diagram of the present invention showing an exemplary computer system that, when appropriately configured or designed, can serve as an exemplary system and method for automated cooking.

### DESCRIPTION

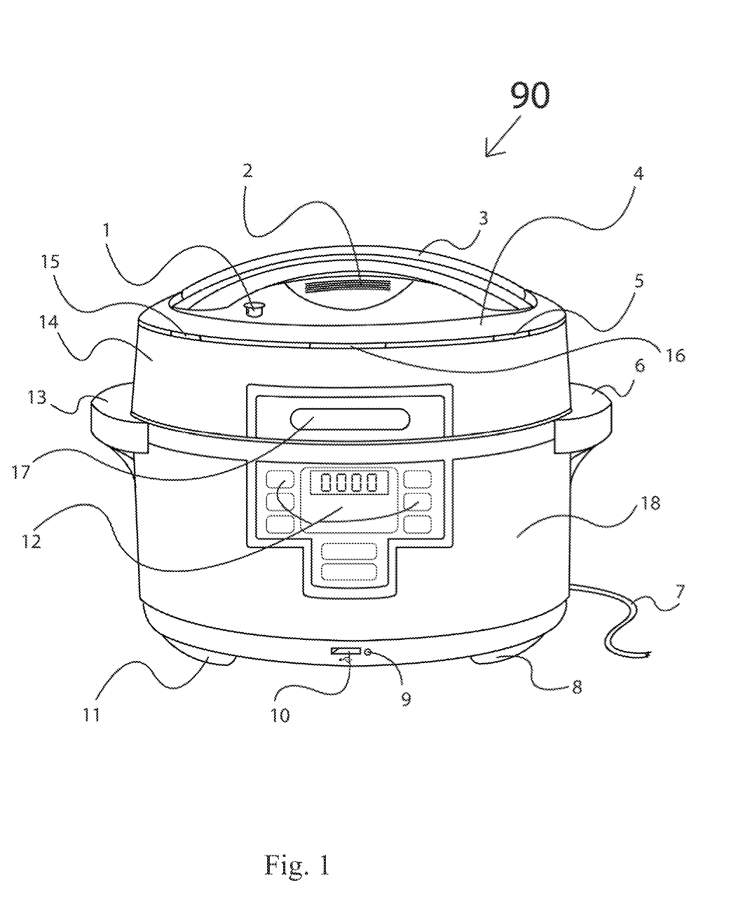

One embodiment of an automatic cooking system 90 is illustrated in FIGS. 1 through 7. The automatic cooking system 10 comprises of the following: a housing 18 configured to contain and/or mix and/or cook the at least one ingredient. In some embodiments, the housing 18 comprises a substantially cylindrical shape. However, in other embodiments, the housing 18 may include, without limitation, a cube, a rectangle, a sphere, and a pyramid shape. Suitable materials for the housing 18 may include, without limitation, stainless steel, metal alloy, rigid polymer, high density polymer, fiberglass, and ceramic. In some embodiments, the housing 18 may include a housing lid 4 to regulate access to the automated cooking system 90. The housing lid 4 comprises a vent 2, which is configured to at least partially release vapors from the automated cooking system 90. A vapor exit 1 includes longitudinal apertures that provide additional escape routes for the vapors produced during cooking. A housing handle 3, which includes a right handle 6 and a left handle 13, facilitates portability by providing a gripping surface efficacious for transporting the automated cooking system 90. Those skilled in the art will recognize that the automated cooking system 90 may become hot during cooking, whereby the housing handle 3 may be insulated to inhibit burns and potential accidents.

In one embodiment, a plurality of containers 89 is disposed to position in a rotary apparatus 37. Each container 89 is configured to contain the at least one ingredient for cooking. A hot container 34 holds ingredients used for cooking, while a cold container 33 holds ingredients requiring cold temperature for storage. Each container 89 comprises an indicia 36. The indicia 36 is configured to identify the at least one ingredient in the plurality of containers 89. In some embodiments, an indicia sensor 28 is operable to identify the at least one ingredient for cooking Each container 89 further comprises a film 91. The film 91 is disposed to at least partially cover the at least one ingredient, whereby cutting the film 91 allows for dispersion of the at least one ingredient. In some embodiments, a plurality of blades 43 is operable to cut the film 91 for dispersing the at least one ingredient from each container 89. In this manner, the at least one ingredient disperses from each container 89 through a first funnel 44 or a second funnel 50 to its respective cooking device.

In one embodiment, a cooker 68 is configured to receive the at least one ingredient for cooking and/or mixing. The cooker 68 comprises a cooker lid 59, which is disposed to cover an open end of the cooker 68. The cooker lid 59 comprises an ingredient port 92 for receiving the at least one ingredient form the first funnel 44. The cooker lid 59 further comprises a sauce port 93 for receiving a sauce. The cooker 68 further comprises a mixing mechanism 57 for mixing the at least one ingredient.

In one embodiment of the present invention, the automated cooking system 90 includes a sauce cooker 82 configured to receive the at least one ingredient for mixing and/or cooking the sauce. The sauce cooker comprises a sauce lid 65 for covering an open end of the sauce cooker 82. The sauce lid 65 comprises a sauce lid reception port 64 for receiving the at least one ingredient. The sauce lid 65 further comprises a sauce lid dispenser port 63 for dispensing the sauce into the cooker 68. In some embodiments, a tilting mechanism 74 is operable to pivot the sauce cooker 82 in an orientation for dispensing the sauce into the cooker 68 through the sauce lid dispenser port 63. In some embodiments, the sauce cooker 82 further comprises a heating device 79 for heating and/or agitating the sauce. In some embodiments, the automated cooking system 90 includes a liquid container 62 configured to contain a liquid for dispensing to the cooker 68 and/or the sauce cooker 82.

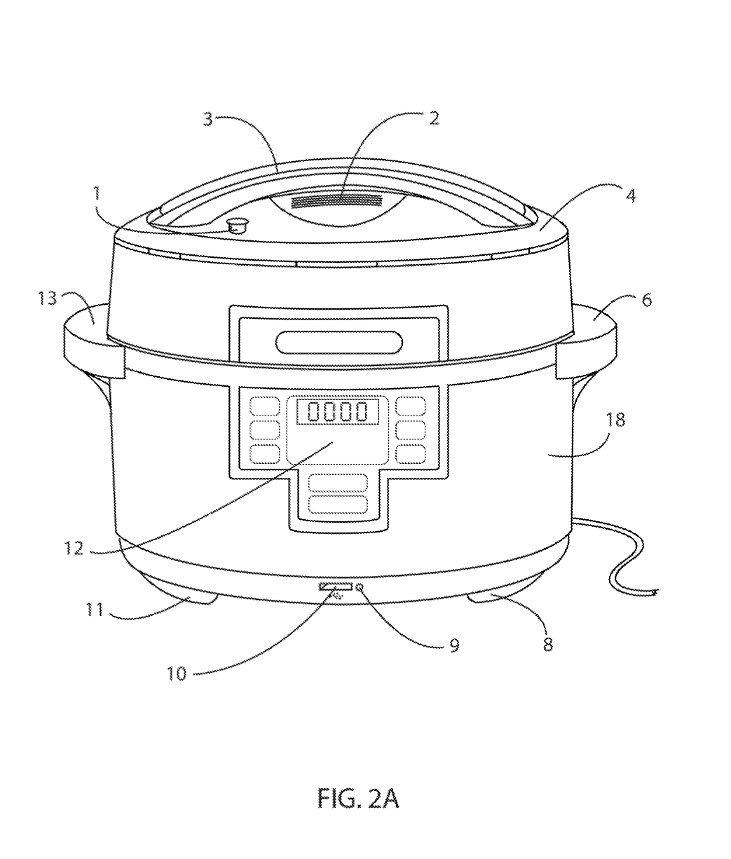

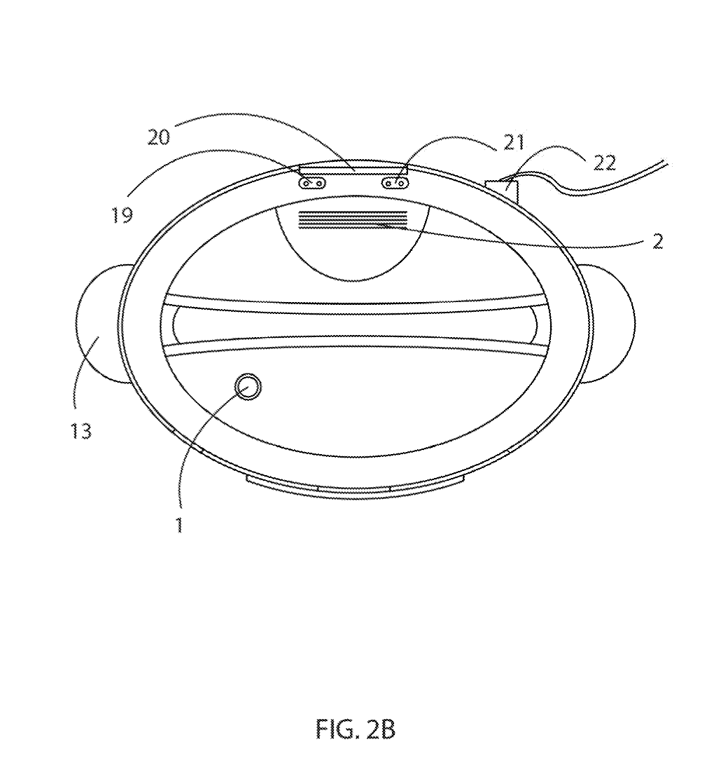

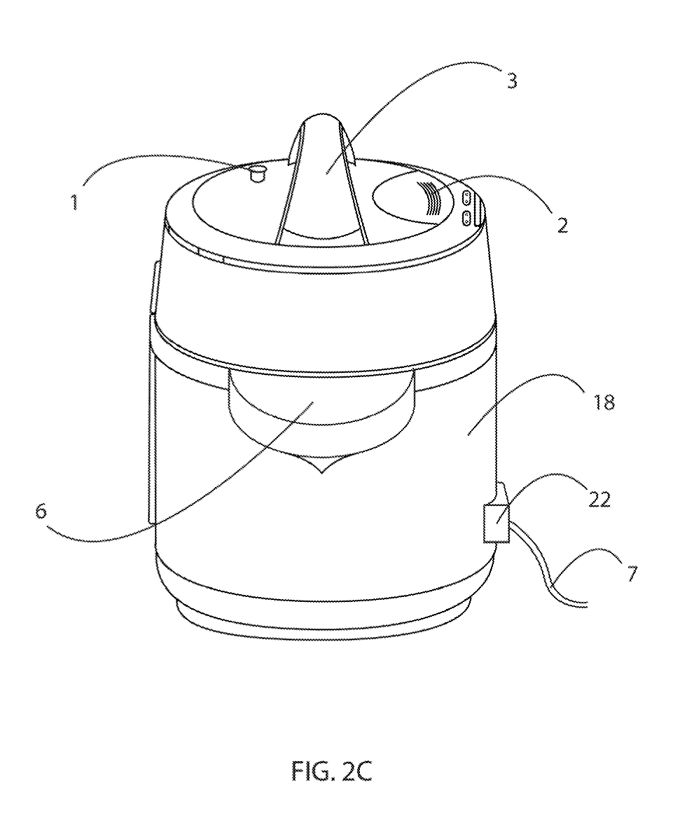

In one embodiment of the present invention, the automated cooking system 90 functions to receive the plurality of containers 89, each holding at least one ingredient, into a cooker 68 and a sauce cooker 82 for automatically dispensing, agitating, and cooking the at least one ingredient to form a predetermined meal, as referenced in FIG. 1. The automated cooking system 90 includes a housing 18 configured to contain, cook, and protect at least one ingredient. The housing rests on a right foot 8 and a left foot 11 for support on a ground surface. In one embodiment, each foot 8, 11 is adjustable to raise and lower. The housing 18 further includes a control panel 12 for controlling the cooking parameters. For example, without limitation, the control panel 12 may include a digital display that shows cooking time, temperature, and the predetermined meal being cooked. A plurality of buttons may be operable to increase or decrease the cooking temperature and duration (FIGS. 2A, 2B, and 2C). A central circuitry 85 transmits electricity and data signals to various components in the automated cooking system 90. An information display portion 17 provides a space for a manufacturer to display information, such as company name, instructions, and warnings. In some embodiments, the housing 18 includes a 120 volt power outlet socket 22 that joins with a power outlet cable 7 for receiving power from an external power source. However, in other embodiments, the power source may include an internal battery.

In one embodiment, the housing lid 4 regulates access to the interior of the automated cooking system 90, and further helps to control the cooking process. A left housing screw 19 and a right housing screw 21 help secure the housing lid 4 to the housing 18. The housing lid 4 includes a vent 2 for helping to regulate the cooking parameters and at least partially releasing vapors from the automated cooking system 90. A lower lid 14 may include an insulator to distinguish the housing lid 4 from the housing 18. A left lid inner screw 26 and a right lid inner screw 30 help secure the lower lid 14 to the housing lid 4. A central ridge 16, a right ridge 5, and a left ridge 15 provide a space that is configured to be operable for a hand to lift the housing lid 4. A left lid hinge screw 23 and a right lid hinge screw 32 secure a hinge on the housing lid 4 for pivotally opening and closing the housing lid 4. The housing lid 4 further includes a lid window 20 for viewing the interior components and cooking conditions of the housing 18. A housing lid cable 25 provides power to the housing lid 4. A processor hinge cable 24 carries commands rom the processor 76 to the housing lid 4.

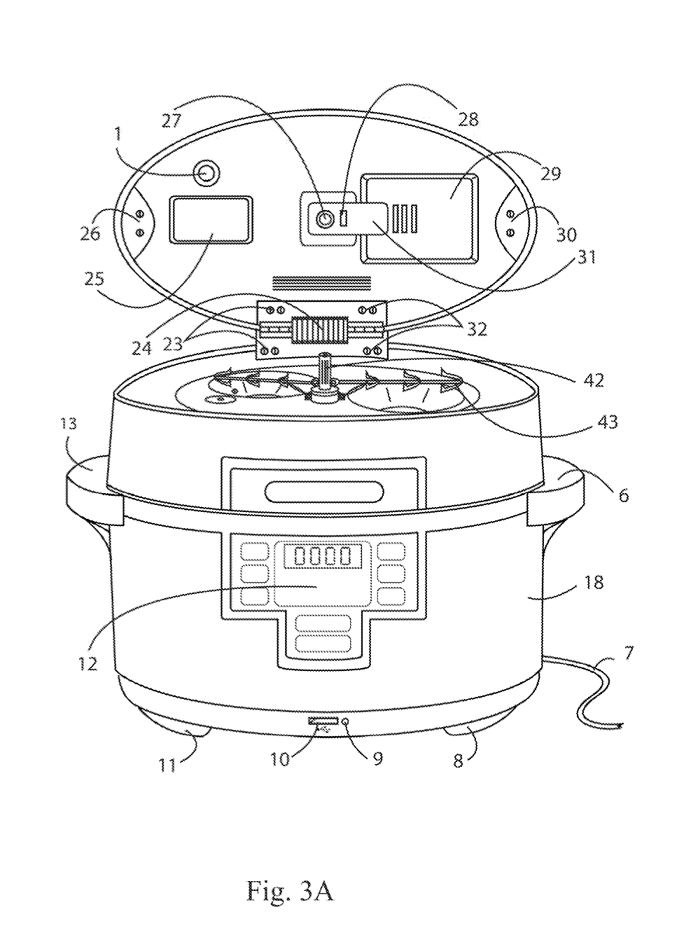

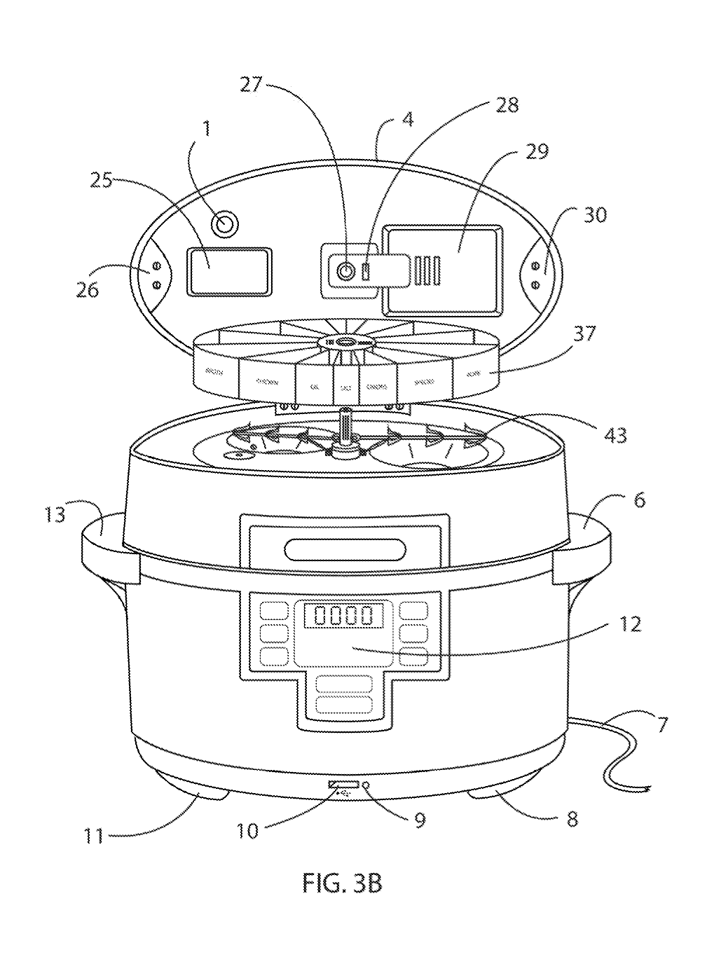

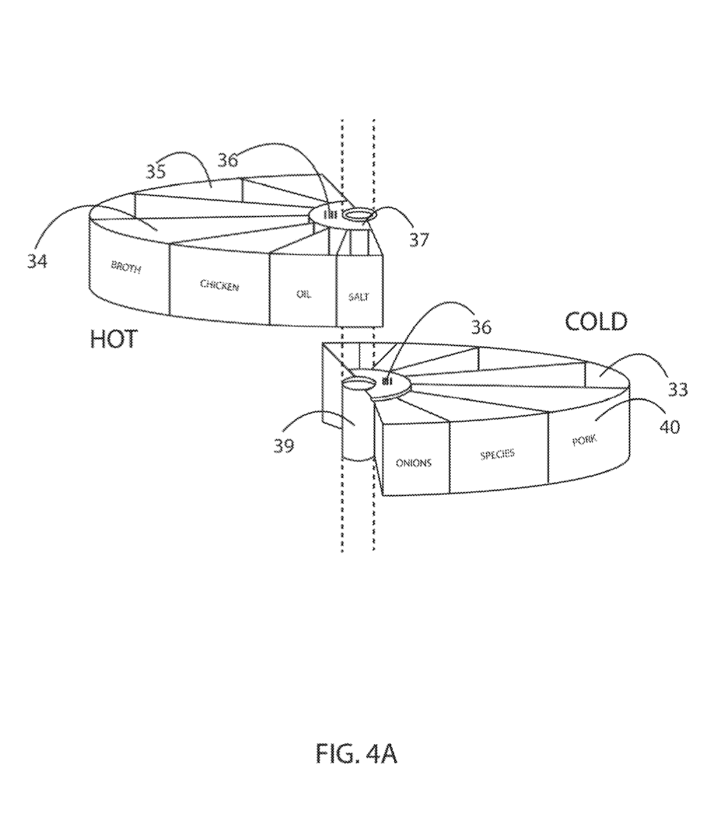

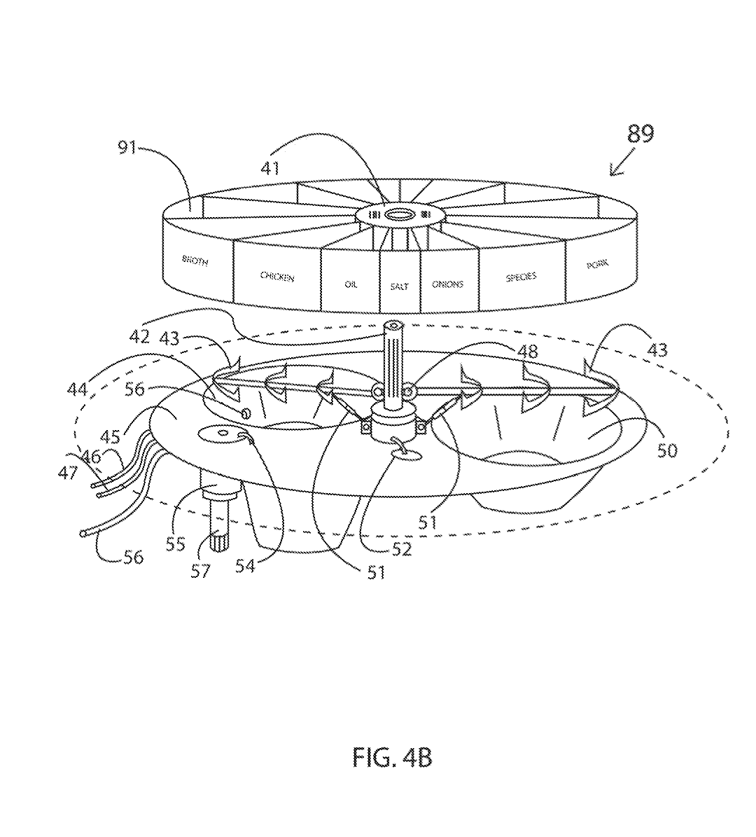

Within the automated cooking system 90, a plurality of containers 89 holds the at least one ingredient used for cooking a predetermined meal, as referenced in FIGS. 3A and 3B. Those skilled in the art will recognize that the ingredients may include an eclectic selection of interchangeable ingredients, whereby different meals may be created depending on the types of ingredients. The at least one ingredient is coordinated with cooking parameters controlled by a processor and other data storage devices. For example, without limitation, a beef stew meal may include potatoes, peas, carrots, and beef cubes. However, if the carrot container is empty, the processor may select celery to replace the carrots. In some embodiments, the plurality of containers 89 rest within a rotary apparatus 37. The rotary apparatus 37 is operable to rotatably position each container 89 for dispensing the at least one ingredient in a predetermined synchronization (FIGS. 4A and 4B). A rotary cylinder 39 slidably engages around a rotary gear 42 for rotating the rotary apparatus 37. In this manner, the desired container 89 positions over the cooker 68 or the sauce cooker 82. A housing lid rotary axis aperture 27 at least partially receives an upper end of the rotary gear 42, forming a hub. A rotary axis cover 41 helps prevent the at least one ingredient from falling into the rotary cylinder 39. A rotary axis cable 46 provides power to rotate the rotary gear 42. In some embodiments, the rotary apparatus 37 includes a half disc hot container 35 and a half disc cold container 40 for containing hot and cold ingredients. In this manner, ingredient proportions may be better regulated.

In one embodiment of the present invention, each container 89 includes an indicia 36, such as a bar code, to indicate the type of the at least one ingredient. An indicia sensor 28, such as a bar scanner, detects the desired container 89 of the at least one ingredient, and positions each container 89 for dispensing the at least one ingredient. In this manner, myriad combinations of the at least one ingredient may be dispensed to create different meals. The indicia sensor 28 rests in an indicia sensor housing 31. An indicia sensor circuitry 29 provides power to the indicia sensor 28. In some embodiments, a software program and a processor 76 regulate the dispersion of the at least one ingredient. A processor battery 77 powers the processor 76. A first processor circuitry 58 and a second processor circuitry 86 help transmit signals form the processor 76 to various components in the automatic cooking system 90.

In one embodiment of the present invention, each container 89 includes a sidewall and a transparent 91 that forms a protective cover for the top and bottom of the container to help keep the at least one ingredient fresh until dispersion. A plurality of blades 43 position adjacent to the film 91, and serve to cut the film 91. For example, without limitation, the plurality of blades 43 may rotatably pass in proximity to the film 91, and cut the film 91 covering a predetermined container based on commands from the processor. In this manner, the at least one ingredient may dispense from the plurality of containers 89 into the first funnel 44 or the second funnel 50 through a gravitational force. The plurality of blades 43 moves through a blade pulley 48. The blade pulley 48 extends and retracts the plurality of blades 43 with a blade hydraulic spring 51, generating a sawing motion efficacious for cutting the film 91.

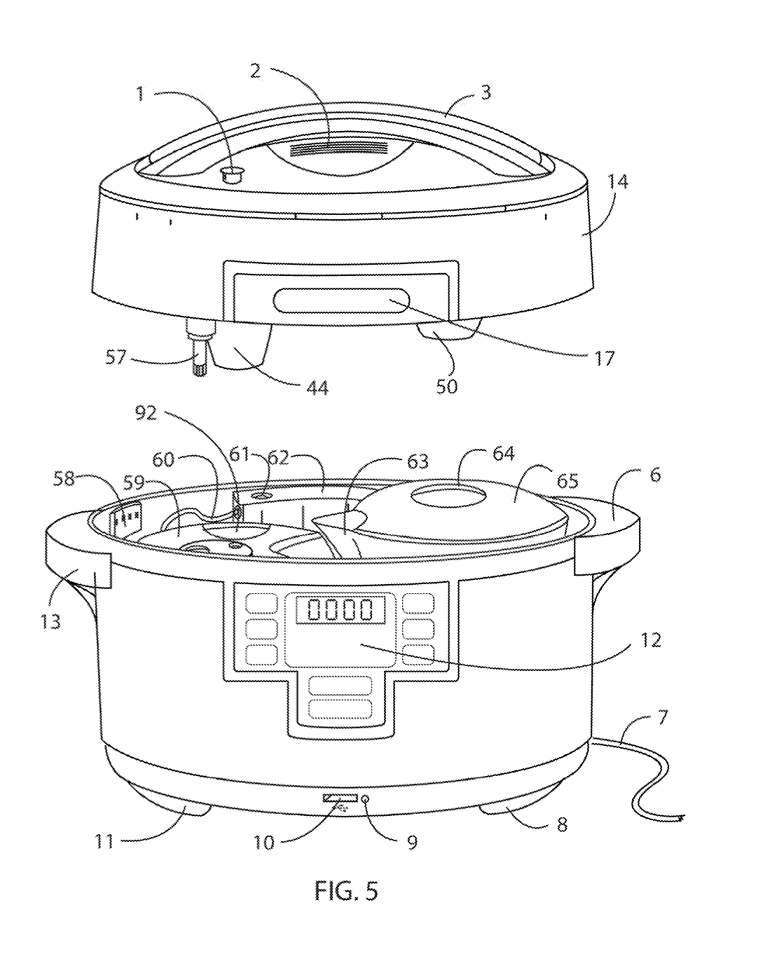

In one embodiment of the present invention, the cooker 68 receives the at least one ingredient from the first funnel 44, as referenced in FIG. 5. The first funnel 44 rests in a funnel support 45. A funnel tube 56 disperses a liquid though the first funnel 44 to help push the at least one ingredient through the first funnel 44, along with gravitational forces. In some embodiments, the cooker 68 may include, without limitation, a pressure cooker, a crock pot, an oven, and a ceramic kettle. Those skilled in the art, in light of the present teachings, will recognize that a pressure cooker is operable to cook a wide variety of meals with minimal intervention from a user. The pressure cooker performs the process of cooking food by utilizing water or other cooking liquid in a sealed vessel, which does not permit air or liquids to escape below a pre-set pressure. Further, pressure cookers may be utilized used for cooking food quicker than conventional cooking methods, thereby conserving energy. The cooker 68 further joins with a cooker heating element 71 for heating the at least one ingredient in the cooker 68. A cooker weight sensor 70 positions on a lower surface of the cooker 68 for measuring the weight of the at least one ingredient. A cooker temperature sensor 73 is operable to measure the temperature of the at least one ingredient during cooking.

A cooker circuitry 84 serves to carry electricity and data signals to and from the cooker 68. A cooker processor cable 83 serves to carry commands from the processor 76 to the cooker 68. A central motor cable 52 serves to carry power from any motors that may actuate the cooker 68. A cooker cable 47 provides power to the cooker 68.

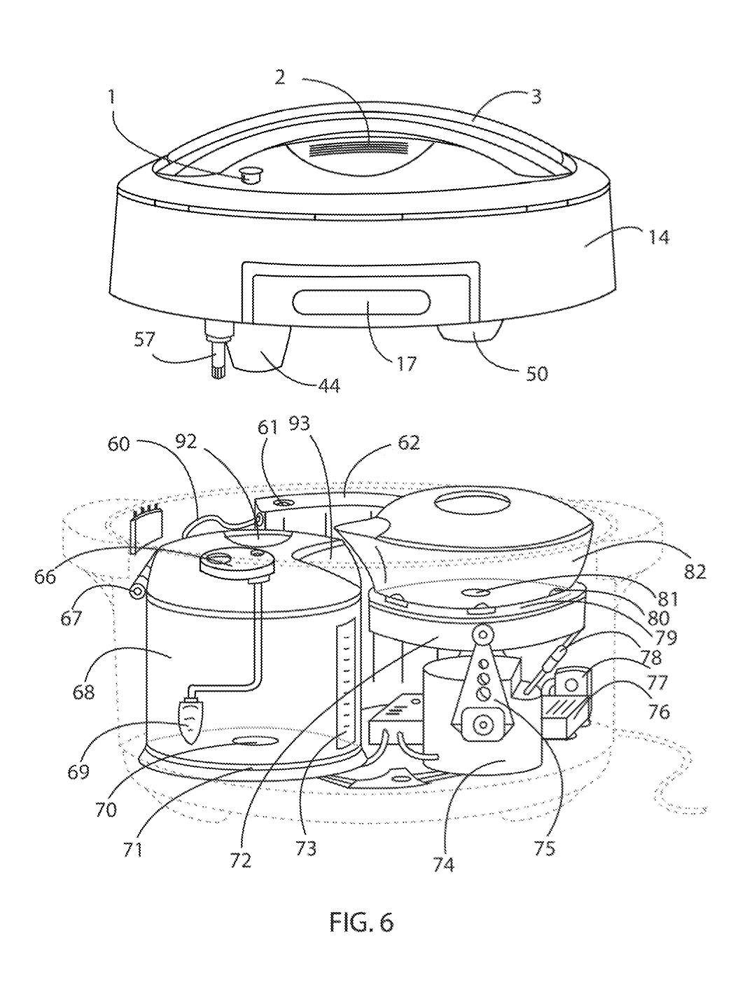

In one embodiment of the present invention, the cooker 68 includes a cooker lid 59 that secures on an open end of the cooker 68 to form a tight, high pressure seal inside the cooker 68. A cooker hinge 67 positions between the cooker lid 59 and the cooker 68 to pivotally open and close the cooker lid 59. The cooker lid 59 includes an ingredient port 92 for receiving the at least one ingredient. The cooker lid 59 further includes a sauce port 93 for receiving a sauce, such as gravy (FIG. 6). In some embodiments, a liquid container 62 positions in proximity to the cooker to provide a liquid, including, without limitation, water to the cooker 68. A liquid tube 60 carries the liquid to the cooker 68. A liquid container port 61 provides an aperture for filling the liquid container 62 with the liquid, including water. The water may form a vapor inside the cooker 68 for heating the at least one ingredient inside the cooker 68. In some embodiments, a mixing mechanism 57 extends into the cooker 68 through the ingredient port 92 for mixing the at least one ingredient in the cooker 68. A mixer tip 69 positions on a terminal end of the mixing mechanism 57 for engaging the at least one ingredient. A mixing motor 55 powers the mixing mechanism 57. The mixing motor 55 may rest protected in a mixing motor hub 66. A mixer cable 54 provides power to the mixing motor 55.

In one embodiment of the present invention, a sauce cooker 82 receives the at least one ingredient from the second funnel 50. The sauce cooker 82 includes a sauce lid 65 for preventing spillage of the sauce. A sauce lid reception port 64 provides an aperture for the at least one ingredient to enter into the sauce cooker 82 from the plurality of containers 89. In this manner, gravity forces the at least one ingredient into the sauce cooker 82 to form the desired sauce. In some embodiments, the sauce cooker 82 rests in an adjustable base 80. The adjustable base 80 serves to provide a framework for supporting the sauce cooker 82. A sauce cooker base 74 at least partially encircles the sauce cooker 82 to help tilt and agitate the sauce cooker 82. A sauce cooker weight sensor 81 positions on a lower surface of the sauce cooker 82 for measuring the weight of the at least one ingredient. A sauce cooker weight sensor cable 94 provides power to the sauce cooker weight sensor 81.

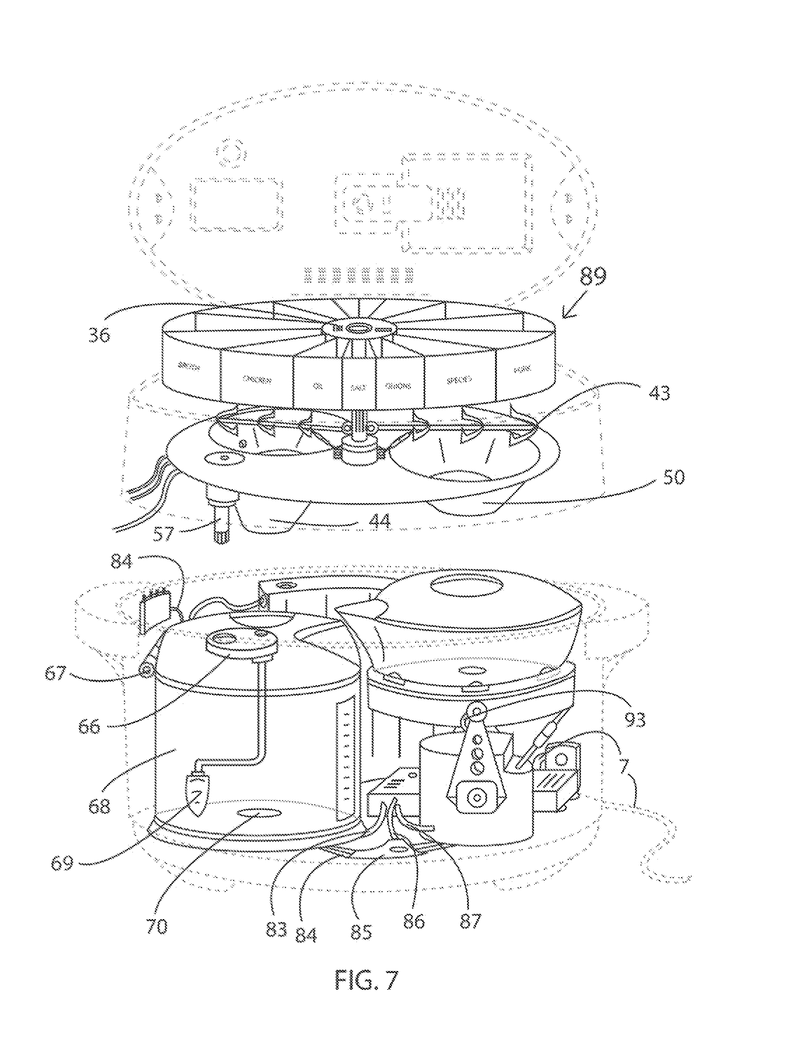

In some embodiments, the sauce cooker 82 may include a tilting mechanism 74 that is operable to pivot the sauce cooker 82, as referenced in FIG. 7. In this manner, the sauce cooker 82 may dispense the sauce through the sauce lid dispenser port 63, located on the sauce lid 65, through the sauce port 93 on the cooker lid 59. The processor 76 regulates when the sauce is sufficiently heated and mixed before actuating the tilting mechanism 74. A tilting arm 75 joins the sauce cooker 82 to the tilting mechanism 74. A sauce cooker hydraulic piston 78 extends and retracts to actuate the tilting arm 75. A tilting mechanism cable 87 provides power to the tilting mechanism 74. In some embodiments, the sauce cooker 82 engages a heating device 79 for heating the sauce. The heating device 79 may also be operable to vibrate and tilt for mixing the sauce in the sauce cooker 82. In some embodiments, the heating device 79 may include, without limitation, an electromechanical plate.

In one embodiment of the present invention, the automated cooking system 90 includes a Wi-Fi reception portion for receiving commands pertinent to meal selection, starting times for cooking, and various cooking parameters. A USB port 10 is configured to receive programs and commands from a data storage device for updating recipes and cooking start times. In some embodiments, a USB indicator 9 may illuminate when the USB port 10 receives data.

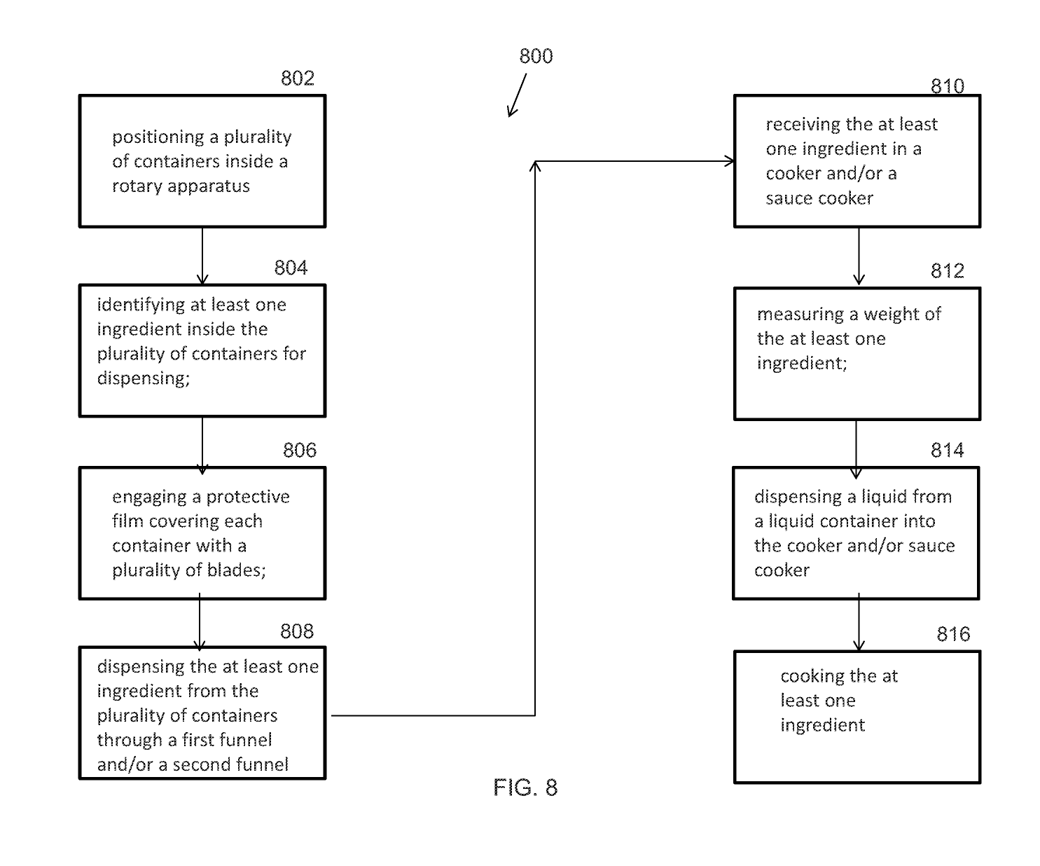

In one embodiment of the present invention, in operation, an automated cooking method 800 provides a novel process for cooking at least one ingredient, as referenced in FIG. 8, The automated cooking method 800 may include an initial Step 802 of positioning a plurality of containers inside the rotary apparatus 37.

The method 800 may then include a Step 804 of identifying at least one ingredient inside the plurality of containers 89 for dispensing. The plurality of containers 89 holds the at least one ingredient used for cooking a predetermined meal. In this manner, an eclectic selection of interchangeable ingredients can be used to form different meals. The indicia 36 on each container 89 helps identify the at least one ingredient.

In one embodiment, a Step 806 includes engaging a protective film 91 that covers each container 89 with a plurality of blades 43 that cut the film 91, and thereby dispense the at least one ingredient. The plurality of blades 43 moves through a blade pulley 48. The blade pulley 48 extends and retracts the plurality of blades 43 with a blade hydraulic spring 51.

A Step 808 comprises dispensing the at least one ingredient from the plurality of containers 89 through a first funnel 44 and/or a second funnel 50. The sawing motion of the plurality of blades 43 cuts the thin film 91 to disperse the at least one ingredient in a synchronized order.

In some embodiments, a Step 810 includes receiving the at least one ingredient in a cooker 68 and/or a sauce cooker 82. The first funnel 44 carries the at least one ingredient to the cooker 68. The second funnel 50 carries the at least one ingredient to the sauce cooker 82. Gravity and a liquid from the funnel tube 56 help move the at least one ingredient through each funnel 44, 50.

A Step 812 includes measuring a weight of the at least one ingredient with the cooker weight sensor 70 and/or the sauce cooker weight sensor 81. The weight may be utilized to measure ingredients for enhanced cooking.

The method 800 may then include a Step 814 of dispensing a liquid from the liquid container 62 into the cooker 68 and/or sauce cooker 82. The liquid includes water, and is efficacious for creating vapor and pressure in a pressure cooker.

Finally, a Step 816 includes cooking the at least one ingredient. The cooking parameters may be set by a user, and regulated by the processor 76.

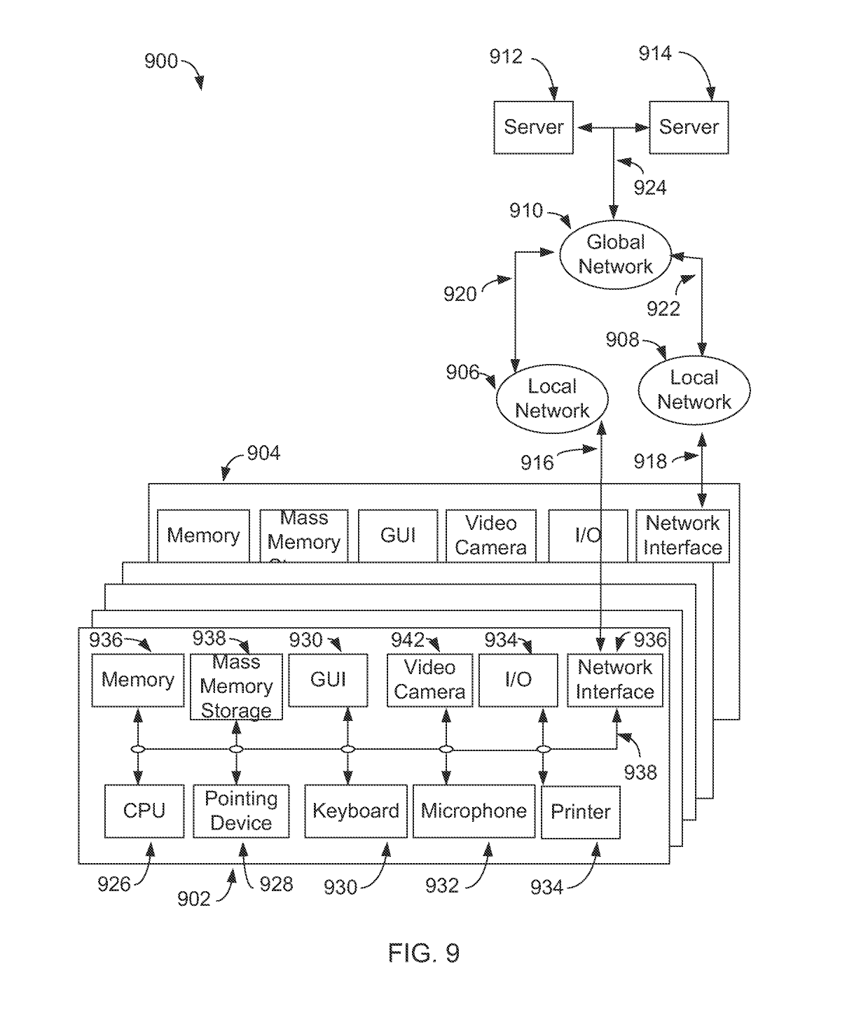

FIG. 9 is a block diagram depicting an exemplary client/server system which may be used by an exemplary web-enabled/networked embodiment of the present invention.

A communication system 900 includes a multiplicity of clients with a sampling of clients denoted as a client 902 and a client 904, a multiplicity of local networks with a sampling of networks denoted as a local network 906 and a local network 908, a global network 910 and a multiplicity of servers with a sampling of servers denoted as a server 912 and a server 914.

Client 902 may communicate bi-directionally with local network 906 via, a communication channel 916. Client 904 may communicate bi-directionally with local network 908 via a communication channel 918. Local network 906 may communicate bi-directionally with global network 910 via a communication channel 920. Local network 908 may communicate bi-directionally with global network 910 via a communication channel 922. Global network 910 may communicate bi-directionally with server 912 and server 914 via a communication channel 924. Server 912 and server 914 may communicate bi-directionally with each other via communication channel 924. Furthermore, clients 902, 904, local networks 906, 908, global network 910 and servers 912, 914 may each communicate bi-directionally with each other.

In one embodiment, global network 910 may operate as the Internet. It will be understood by those skilled in the art that communication system 900 may take many different forms. Non-limiting examples of forms for communication system 900 include local area networks (LANs), wide area networks (WANs), wired telephone networks, wireless networks, or any other network supporting data communication between respective entities.

Clients 902 and 904 may take many different forms. Non-limiting examples of clients 902 and 904 include personal computers, personal digital assistants (PDAs), cellular phones and smartphones.

Client 902 includes a CPU 926, a pointing device 928, a keyboard 930, a microphone 932, a printer 934, a memory 936, a mass memory storage 938, a GUI 940, a video camera 942, an input/output interface 944 and a network interface 946.

CPU 926, pointing device 928, keyboard 930, microphone 932, printer 934, memory 936, mass memory storage 938. GUI 940, video camera 942, input/output interface 944 and network interface 946 may communicate in a unidirectional manner or a bi-directional manner with each other via a communication channel 948. Communication channel 948 may be configured as a single communication channel or a multiplicity of communication channels.

CPU 926 may be comprised of a single processor or multiple processors. CPU 926 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 936 is used typically to transfer data and instructions to CPU 926 in a bi-directional manner. Memory 936, as discussed previously, may include any suitable computer-readable media, intended for data storage, such as those described above excluding any wired or wireless transmissions unless specifically noted. Mass memory storage 938 may also be coupled bi-directionally to CPU 926 and provides additional data storage capacity and may include any of the computer-readable media described above. Mass memory storage 938 may be used to store programs, data and the like and is typically a secondary storage medium such as a hard disk. it will be appreciated that the information retained within mass memory storage 938, may, in appropriate cases, be incorporated in standard fashion as part of memory 936 as virtual memory.

CPU 926 may be coupled to GUI 940. GUI 940 enables a user to view the operation of computer operating system and software. CPU 926 may be coupled to pointing device 928. Non-limiting examples of pointing device 928 include computer mouse, trackball and touchpad. Pointing device 928 enables a user with the capability to maneuver a computer cursor about the viewing area of GUI 940 and select areas or features in the viewing area of GUI 940. CPU 926 may be coupled to keyboard 930. Keyboard 930 enables a user with the capability to input alphanumeric textual information to CPU 926. CPU 926 may be coupled to microphone 932. Microphone 932 enables audio produced by a user to be recorded, processed and communicated by CPU 926. CPU 926 may be connected to printer 934. Printer 934 enables a user with the capability to print information to a sheet of paper. CPU 926 may be connected to video camera 942. Video camera 942 enables video produced or captured by user to be recorded, processed and communicated by CPU 926.

CPU 926 may also be coupled to input/output interface 944 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 926 optionally may be coupled to network interface 946 which enables communication with an external device such as a database or a computer or telecommunications or internet network using an external connection shown generally as communication channel 916, which may be implemented as a hardwired or wireless communications link using suitable conventional technologies. With such a connection, CPU 926 might receive information from the network, or might output information to a network in the course of performing the method steps described in the teachings of the present invention.

Thus the reader will see that the automated cooking system 90 and method 800 provide an efficient process for automatically dispensing at least one ingredient, agitating the at least one ingredient, and cooking the at least one ingredient to form a predetermined meal.

While the inventor's above description contains many specificities, these should not be construed as limitations on the scope, but rather as an exemplification of several preferred embodiments thereof. Many other variations are possible. For example, the filter cleaning system 10 could be utilized for cleaning large filters 14 in factories. Accordingly, the scope should be determined not by the embodiments illustrated, but by the appended claims and their legal equivalents.

1. A cooking system for cooking a predetermined meal, the cooking system comprising:
a housing, the housing being configured to contain and/or mix and/or cook at least one ingredient, the housing comprising a housing lid, the housing lid being configured to regulate access to the housing, the housing lid comprising a vent, the vent being configured to at least partially release vapors from the housing;
a plurality of containers, the plurality of containers being disposed to position in a rotary apparatus, each container being configured to contain the at least one ingredient, each container comprising an indicia, the indicia being configured to identify the at least one ingredient, wherein an indicia sensor is operable to identify the at least one ingredient for cooking, each container further comprising a film, the film being disposed to at least partially cover each container;
a plurality of blades, the plurality of blades being operable to cut the film for dispersing the at least one ingredient from each container, wherein the at least one ingredient disperses from each container through a first funnel or a second funnel; a cooker, the cooker being configured to receive the at least one ingredient for cooking and/or mixing, the cooker comprising a cooker lid, the cooker lid being disposed to cover an open end of the cooker, the cooker lid comprising an ingredient port for receiving the at least one ingredient form the first funnel, the cooker lid further comprising a sauce port for receiving a sauce, the cooker further comprising a mixing mechanism for mixing the at least one ingredient;
a sauce cooker, the sauce cooker being configured to receive the at least one ingredient for mixing and/or cooking the sauce, the sauce cooker comprising a sauce lid for covering an open end of the sauce cooker, the sauce lid comprising a sauce lid reception port for receiving the at least one ingredient, the sauce lid further comprising a sauce lid dispenser port for dispensing the sauce into the cooker, wherein a tilting mechanism is operable to pivot the sauce cooker in an orientation for dispensing the sauce into the cooker, the sauce cooker further comprising a heating device for heating and/or agitating the sauce; and
a liquid container, the liquid container being configured to contain a liquid for dispensing to the cooker and/or the sauce cooker.

2. The cooking system of claim 1, wherein the cooking system comprises a processor fix regulating a plurality of cooking parameters.

3. The cooking system of claim 1, wherein the housing comprises a substantially cylindrical shape.

4. The cooking system of claim 1, wherein the housing lid comprises the indicia sensor.

5. The cooking system of claim 1, wherein the indicia comprises a bar code.

6. The cooking system of claim 1, wherein the rotary apparatus comprises a hot portion for receiving each container of a hot ingredient, and a cold portion for receiving each container of a cold ingredient

7. The cooking system of claim 1, wherein the plurality of blades are operable to rotatably engage the film for releasing the at least one ingredient form the plurality of containers.

8. The cooking system of claim 1, wherein the cooker comprises a pressure cooker.

9. The cooking system of claim 1, wherein the cooker comprises a cooker weight sensor for measuring the weight of the at least one ingredient in the cooker.

10. The cooking system of claim 1, wherein the cooker comprises a cooker temperature sensor for measuring the temperature of the at least one ingredient in the cooker.

11. The cooking system of claim 1, wherein the liquid comprises water.

12. The cooking system of claim 1, wherein the mixing mechanism comprises a mixing motor for actuating the mixing mechanism.

13. The cooking system of claim 1, wherein the sauce cooker comprises a sauce cooker weight sensor for measuring the weight of the at least one ingredient in the sauce cooker.

14. The cooking system of claim 1, wherein the heating device comprises an electromechanical plate.

15. The cooking system of claim 1, wherein the cooking system comprises a Wi-Fi reception portion for receiving commands to control meal selection and cooking parameters.

16. The cooking system of claim 1, wherein the cooking system comprises a USB port for receiving programs and commands from a data storage device for updating recipes and cooking parameters.

17. A cooking method for automated cooking, the cooking method comprising:
positioning a plurality of containers inside a rotary apparatus;
identifying at least one ingredient inside the plurality of containers for dispensing;
engaging, with a plurality of blades, a protective film covering each container;
dispensing the at least one ingredient from the plurality of containers through a first funnel and/or a second funnel;
receiving the at least one ingredient in a cooker and/or a sauce cooker;
measuring a weight of the at least one ingredient;
dispensing a liquid from a liquid container into the cooker and/or sauce cooker;
cooking the at least one ingredient.

18. A cooking system for cooking a predetermined meal, the cooking system comprising:
a housing, the housing comprising a substantially cylindrical shape, the housing being configured to contain and/or mix and/or cook at least one ingredient, the housing further comprising a housing handle for transporting the housing, the housing further comprising a housing lid, the housing lid being configured to regulate access to the housing, the housing lid comprising a vent, the vent being configured to at least partially release vapors from the housing, the housing lid further comprising a vapor exit for releasing vapor;
a plurality of containers, the plurality of containers being disposed to position in a rotary apparatus, each container being configured to contain the at least one ingredient, each container comprising an indicia, the indicia comprising a bar code, the indicia being configured to identify the at least one ingredient, wherein an indicia sensor is operable to identify the at least one ingredient for cooking, the indicia sensor comprising a laser scanner, each container further comprising a film, the film being disposed to at least partially cover each container, the film comprising a polyethylene film;
a plurality of blades, the plurality of blades being operable to cut the film for dispersing the at least one ingredient from each container, wherein the at least one ingredient disperses from each container through a first funnel or a second funnel; a cooker, the cooker being configured to receive the at least one ingredient for cooking and/or mixing from the first funnel, the cooker comprising a cooker weight sensor for measuring the weight of the at least one ingredient in the cooker, the cooker further comprising a cooker temperature sensor for measuring the temperature of the at least one ingredient in the cooker, the cooker further comprising a cooker lid, the cooker lid being disposed to cover an open end of the cooker, the cooker lid comprising an ingredient port for receiving the at least one ingredient form the first funnel, the cooker lid further comprising a sauce port for receiving a sauce, the cooker further comprising a mixing mechanism for mixing the at least one ingredient, the mixing mechanism comprising a mixing motor;
a sauce cooker, the sauce cooker being configured to receive the at least one ingredient for mixing and/or cooking the sauce from the second funnel, the sauce cooker comprising a sauce cooker weight sensor for measuring the weight of the at least one ingredient in the sauce cooker, the sauce cooker comprising a sauce lid for covering an open end of the sauce cooker, the sauce lid comprising a sauce lid reception port for receiving the at least one ingredient, the sauce lid further comprising a sauce lid dispenser port for dispensing the sauce into the cooker, wherein a tilting mechanism is operable to pivot the sauce cooker in an orientation for dispensing the sauce into the cooker, the tilting mechanism comprising a piston for engaging the sauce cooker, the sauce cooker further comprising a heating device for heating and/or agitating the sauce, the heating device comprising an electromechanical plate;
a liquid container, the liquid container being configured to contain a liquid for dispensing to the cooker and/or the sauce cooker through a liquid tube, the liquid comprising water;
a processor for regulating the cooking method;
a Wi-Fi reception portion for receiving commands to control meal selection and cooking parameters; and
a USB port for receiving programs and commands from a data storage device for updating recipes and cooking parameters.
